(19) United States
(12) Patent Application Publication
(10) Pub. No.: US 2010/0083088 A1
(43) Pub. Date: Apr. 1, 2010

(54) Defining custom formats

(75) Inventors: Jeffery Robert Hunter, Sunnyvale, CA (US); Christopher Douglas Weeldreyer, San Carlos, CA (US)

Correspondence Address: VAN PELT, YI & JAMES LLP AND APPLE COMPUTER, INC., 10050 N. FOOTHILL BOULEVARD, SUITE 200, CUPERTINO, CA, 95014, US

(73) Assignee: Apple Inc.

(21) Appl. No.: 12/286,635

(22) Filed: Sep. 30, 2008

(51) Int. Cl. G06F 17/00

(52) U.S. Cl. 715/217

(57) ABSTRACT

Defining custom cell formats is disclosed. In some embodiments, in response to receiving an indication of a selection of an option to define a custom cell format, a user interface to define the custom cell format is provided, wherein a format element in a definition of the custom cell format in the user interface is represented as a format element token.

### BACKGROUND OF THE INVENTION

Existing spreadsheet applications provide options to create custom number formats. Typically, a definition of a custom number format requires manual entry of plain text codes of the format types desired to be included in the custom number format. Such codes are typically not intuitive and easily remembered, and often the correct codes must be determined by consulting associated documentation.

### BRIEF DESCRIPTION OF THE DRAWINGS

Various embodiments of the invention are disclosed in the following detailed description and the accompanying drawings.

FIG. 1A illustrates an embodiment of a user interface for defining a custom format.

FIGS. 1B-1K illustrate various embodiments associated with format element tokens.

FIGS. 1L-1M illustrate various embodiments associated with conditions.

FIG. 2 illustrates an embodiment of a user interface for defining a custom format.

FIG. 3 illustrates an embodiment of a user interface for defining a custom format.

FIG. 4 illustrates an embodiment of a process for defining a custom cell format.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “cell” refers to a cell associated with at least standard spreadsheet functionality. The term “at least standard spreadsheet functionality” in the context of a cell includes the ability to define the content of one cell in such a way that the content of the one cell is determined based at least in part on the content of one or more other cells, and the content of the one cell is updated automatically without further human action if the content of one or more of the one or more other cells is changed. As used herein, the term “host cell” refers to a cell in a formula editing mode, i.e., a cell into which a formula is being entered. In some embodiments, cells in a spreadsheet application are organized into one or more individual tables or table objects, each of which includes a desired number of rows and columns of cells. In such cases, a sheet or canvas of a spreadsheet document may include a desired number of table objects as well any desired number of other objects such as charts, graphs, images, etc. Although in some of the examples described herein the cells of a spreadsheet application are organized into such table objects, the techniques described herein may be similarly employed with respect to other cell configurations or organizations, such as the (seemingly) infinite single grid or table of cells in each sheet of some typical spreadsheet applications that includes an unlimited (or very large) number of rows and columns of cells. Although many of the examples provided herein are with respect to a spreadsheet application, the techniques described herein may be similarly employed with respect to any application, spreadsheet or otherwise.

A custom cell format may be defined for one or more cells of a spreadsheet application to format the data or values in the cells in a desired manner. In various embodiments, custom formats may be defined for various types of data, such as text, numbers, dates, times, durations, etc. A defined custom format may be named and saved, for example, for later reuse.

Defining a custom format using tokens to represent one or more format elements is disclosed. In some embodiments, various format elements that may be used to define a custom format are represented as tokens in a user interface associated with defining custom formats. As used herein, the term “token” refers to an atomic user interface object or unit. In various embodiments, a token is associated with a variety of user interface object features and/or behaviors. For example, a token may be selected via a single selection operation (e.g., via a single click), a token may be dragged and/or dropped to a desired position, a menu may be associated with a token, a pop-up tool tip that describes a token may be associated with the token, etc. As further described below, representing format elements as graphic tokens (rather than, for example, plain text codes) provides an enhanced user interface experience both in functionality and visual presentation when creating custom formats.

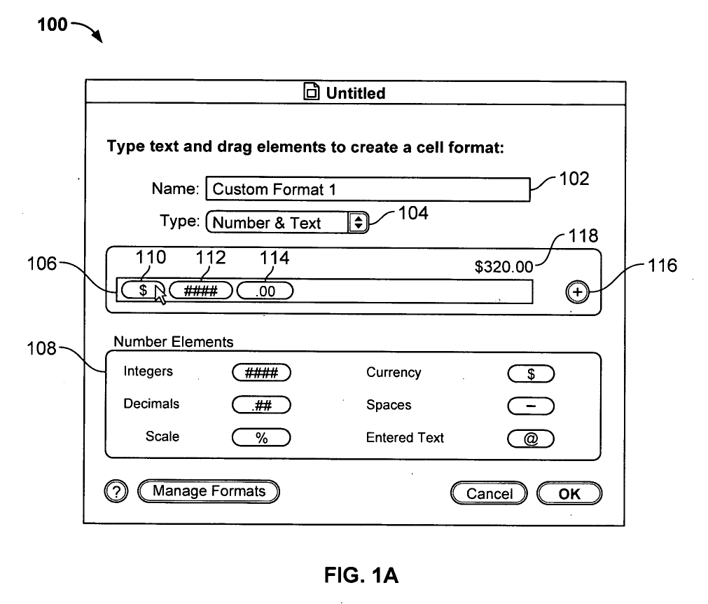

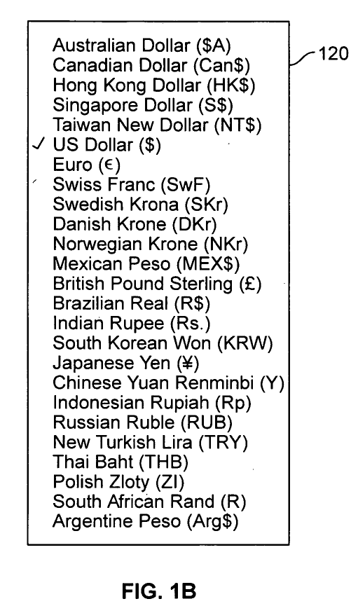

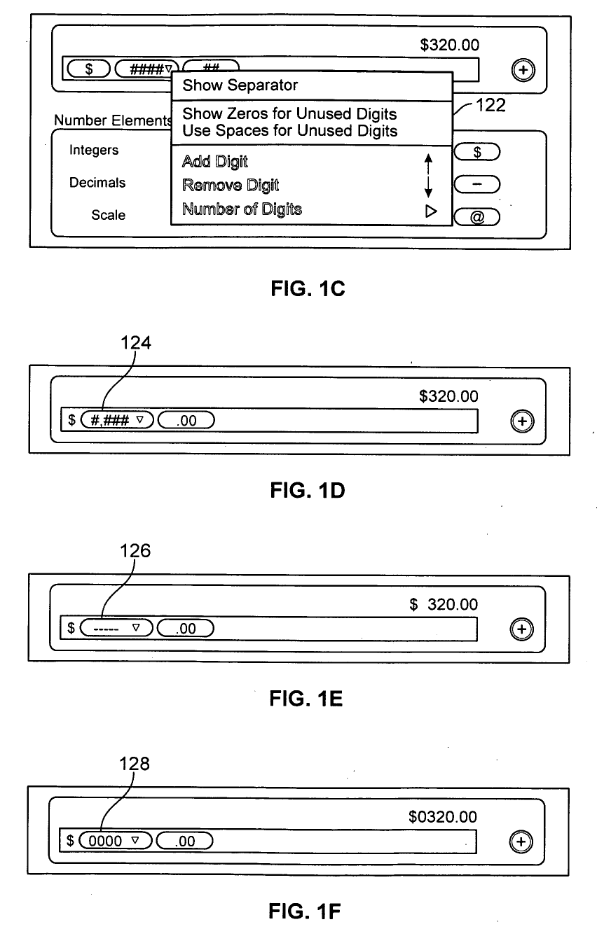

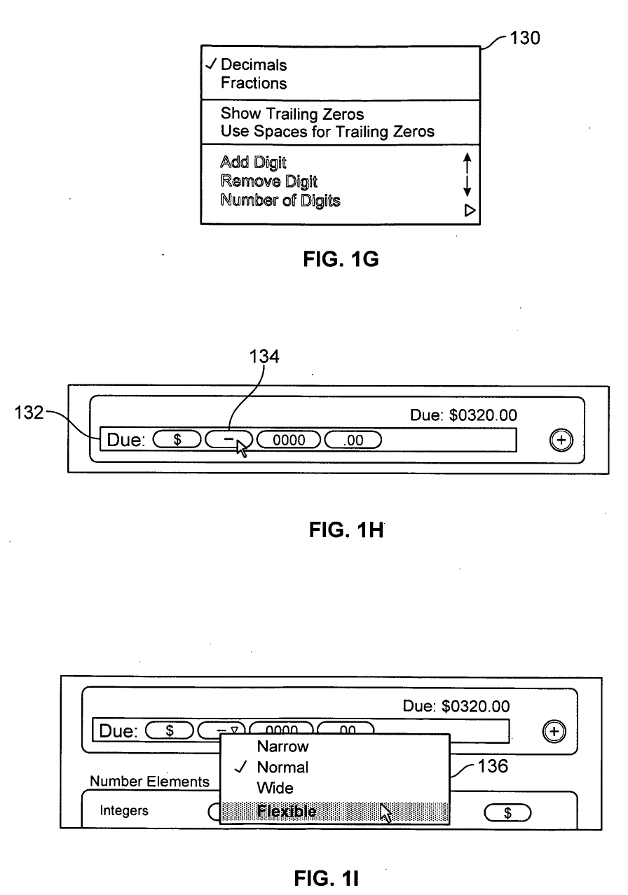

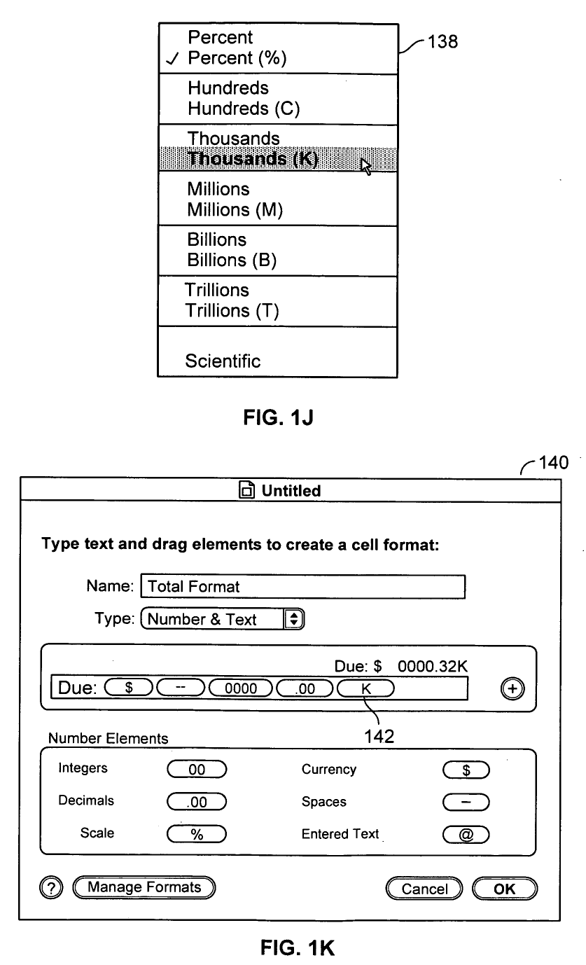

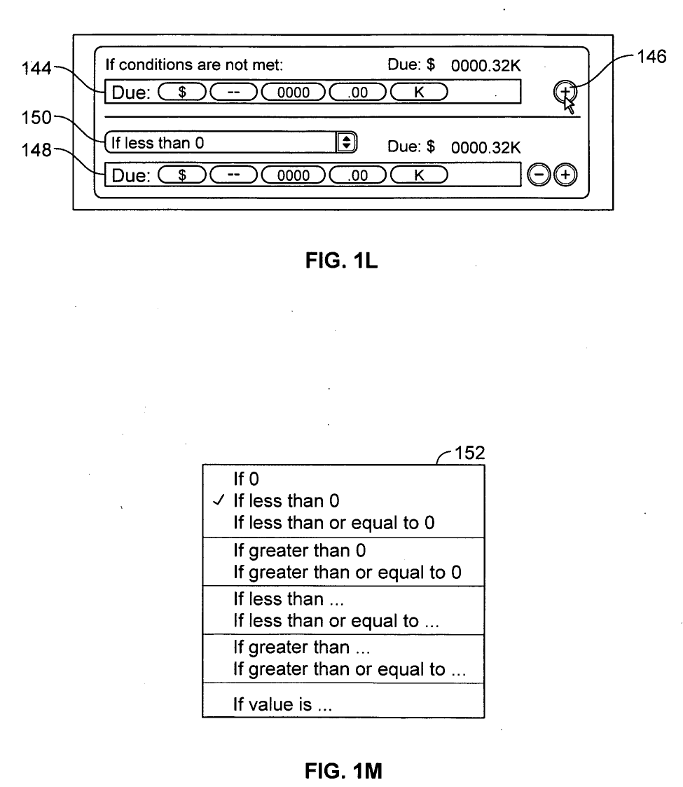

FIG. 1A illustrates an embodiment of a user interface 100 for defining a custom format. As depicted, user interface 100 includes a name field 102 for specifying a name for the custom format, a type menu 104 for specifying and/or selecting a data type for the custom format (e.g., the “Number and Text” type has been selected in the given example), and a definition field 106 for defining the custom format. In some embodiments, a palette of graphical tokens representing format elements that can be used to define a custom format of a prescribed type are provided with a custom format user interface. In the given example, user interface 100 includes a set of format element tokens 108 that can be used to define a custom format of the “Number and Text” type. One or more instances of one or more format element tokens can be dragged and dropped into the definition field to define a custom format. In the given example, a Currency token 110, an Integers token 112, and a Decimals token 114 have been added to definition field 106.

Tokens included in a definition field may be reordered if desired, e.g., by dragging and dropping the tokens to the desired positions in the definition. In some embodiments, a format element token includes a menu for configuring the format of that particular instance of the token. In various embodiments, the menu associated with a token may be accessed by selecting and/or clicking on the token; via a menu disclosure control associated with the token, etc. In some embodiments, the visual representation of formatting depicted on a token may be changed from a default representation based on one more selected formatting options so that, for example, the visual representation of formatting depicted on the token reflects at least some of the selected formatting options. In some embodiments, text may be included in a custom format definition before, between, and/or after tokens included in the definition. In some embodiments, a custom format definition may comprise multiple conditions, i.e., different formats may be defined for different conditions. In the given example, user interface 100 includes a control 116 for adding a new condition, which is further described below. User interface 100 also includes a sample value 118 above definition field 106 that reflects the formatting specified in the definition and in some embodiments is automatically and/or dynamically updated as the definition and/or formatting associated with various tokens included in the definition are modified.

FIGS. 1B-1K illustrate various embodiments associated with format element tokens 108. A Currency token represents a currency symbol in a custom format definition. FIG. 1B illustrates an embodiment of a menu 120 for formatting a Currency token. An Integers token represents an integer in a custom format definition. FIG. 1C illustrates an embodiment of a menu 122 for formatting an Integers token. FIG. 1D illustrates an embodiment of an Integers token 124 with the “Show Separator” option from menu 122 selected, FIG. 1E illustrates an embodiment of an Integers token 126 with the “Use Spaces for Unused Digits” option from menu 122 selected, and FIG. 1F illustrates an embodiment of an Integers token 128 with the “Show Zeros for Unused Digits” option from menu 122 selected. As depicted in the examples of FIGS. 1D-1F, the formatting depicted on a token changes based on the formatting options selected. A Decimals token represents a decimal in a custom format definition. FIG. 1G illustrates an embodiment of a menu 130 for formatting a Decimals token. A Spaces token represents a space in a custom format definition. FIG. 1H illustrates an embodiment of a definition field 132 that includes a Spaces token 134 in the definition. Definition field 132 also includes text (i.e., “Due:”) before the first token. FIG. 1I illustrates an embodiment of a menu 136 for formatting a Spaces token. A Scale token represents a scale of a number in a custom format definition. FIG. 1J illustrates an embodiment of a menu 138 for formatting a Scale token. FIG. 1K illustrates an embodiment of a custom format user interface 140 that includes a Scale token 142 that represents thousands in the definition of the custom format. An Entered Text token represents text in a custom format definition.

In some embodiments, a custom format comprises one or more conditions. FIGS. 1L-1M illustrate various embodiments associated with conditions. FIG. 1L illustrates an embodiment of a custom format definition that includes a condition. In the given example, the definition includes a first definition field 144. A condition is added to the first definition 144 by selection of the plus icon 146, which adds a second definition field 148 and an associated condition menu 150 from which a desired condition can be selected and/or specified. FIG. 1M illustrates an embodiment of a condition menu 152. In the example of FIG. 1L, the first definition 144 is associated with the “else” condition, i.e., it is applied only if one or more specified conditions are not satisfied. In various embodiments, any desired number of conditions may be added to the definition of a custom format.

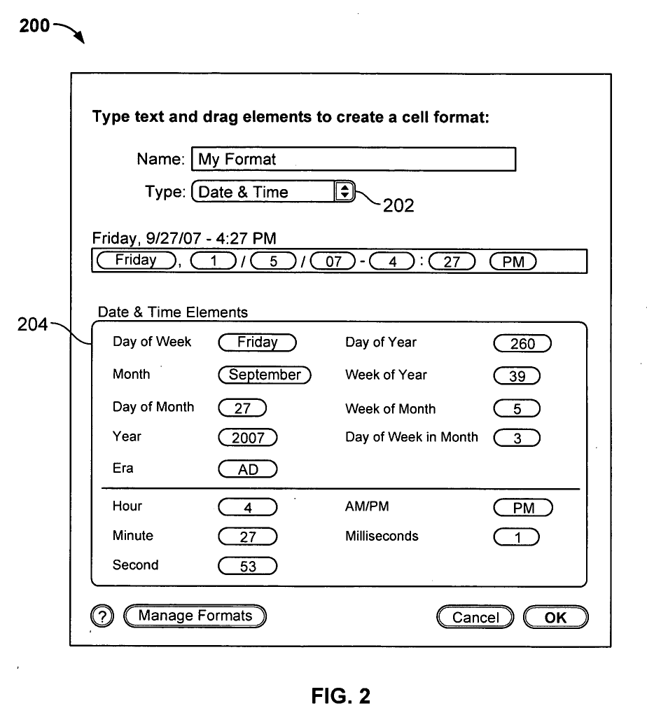

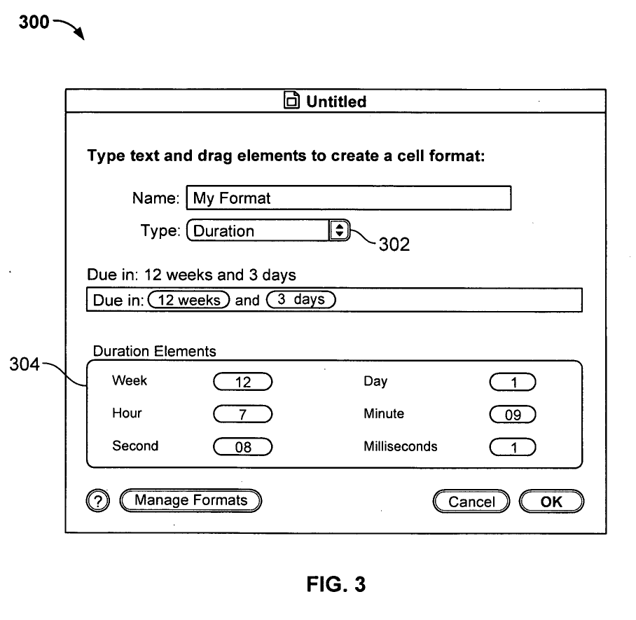

In various embodiments, the types of format element tokens provided with a custom format user interface depend on the type of the custom format being created. FIG. 2 illustrates an embodiment of a user interface 200 for defining a custom format. In the given example, the “Date and Time” type has been selected from type menu 202, and appropriate types of format element tokens 204 that can be used to define a custom format of the “Date and Time” type are provided for specifying a custom format definition. FIG. 3 illustrates an embodiment of a user interface 300 for defining a custom format. In the given example, the “Duration” type has been selected from type menu 302, and appropriate types of format element tokens 304 that can be used to define a custom format of the “Duration” type are provided for specifying a custom format definition.

The custom format user interface described herein allows a user to atomic drag graphical elements and manipulate them, e.g., via a mouse, to change their formats and set options. Although some examples of a custom format user interface have been described, in various embodiments, any appropriate user interface configuration may be employed that allows tokens to be used to specify at least some format elements of a custom format definition.

FIG. 4 illustrates an embodiment of a process for defining a custom format. Process 400 starts at 402 at which an indication of a selection of an option to define a custom cell format is received. At 404, a user interface to define a custom cell format is provided. In some embodiments, a format element in a definition of the custom cell format is represented in the user interface as a format element token. Process 400 subsequently ends. In some embodiments, the user interface provided at 404 comprises one or more of the user interfaces and/or parts thereof illustrated in FIGS. 1A-M, 2, and 3. In some embodiments, the user interface includes a context appropriate palette of format element tokens, one or more of which can be selected to be included in the definition.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A computer program product for defining a custom cell format, the computer program product being embodied in a computer readable storage medium and comprising computer instructions for:
providing a user interface to define a custom cell format;
wherein a format element in a definition of the custom cell format in the user interface is represented as a format element token.

2. The computer program product recited in claim 1, wherein the format element token comprises an atomic user interface object.

3. The computer program product recited in claim 1, wherein the format element token comprises an instance of a prescribed token type.

4. The computer program product recited in claim 1, wherein the format element token includes a menu that includes one or more formatting options for the format element.

5. The computer program product recited in claim 1, further comprising computer instructions for receiving a specification of a type of the custom cell format.

6. The computer program product recited in claim 5, wherein the type comprises one or more of: text, number, date, time, and duration.

7. The computer program product recited in claim 1, further comprising computer instructions for providing with the user interface a palette of one or more format element tokens.

8. The computer program product recited in claim 7, wherein the palette is based at least in part on a type of the custom cell format.

9. The computer program product recited in claim 7, wherein the format element token in the definition is dragged from the palette and dropped into a definition field associated with the definition.

10. The computer program product recited in claim 1, further comprising computer instructions for providing an option to include one or more conditions in the definition.

11. The computer program product recited in claim 1, wherein the definition comprises a plurality of format elements including the format element.

12. The computer program product recited in claim 11, wherein each of at least a subset of format elements included in the definition is represented in the user interface as a format element token.

13. A system for defining a custom cell format, comprising:
a processor configured to provide a user interface to define a custom cell format; and
a memory coupled to the processor and configured to provide the processor with instructions;
wherein a format element in a definition of the custom cell format in the user interface is represented as a format element token.

14. The system recited in claim 13, wherein the format element token comprises an atomic user interface object.

15. The system recited in claim 13, wherein the format element token includes a menu that includes one or more formatting options for the format element.

16. The system recited in claim 13, wherein the processor is further configured to provide with the user interface a palette of one or more format element tokens.

17. A method for defining a custom cell format, comprising:
providing a user interface to define a custom cell format;
wherein a format element in a definition of the custom cell format in the user interface is represented as a format element token.

18. The method recited in claim 17, wherein the format element token comprises an atomic user interface object.

19. The method recited in claim 17, wherein the format element token includes a menu that includes one or more formatting options for the format element.

20. The method recited in claim 17, further comprising providing with the user interface a palette of one or more format element tokens.
